(19) United States
(12) Patent Application Publication
(10) Pub. No.: US 2026/0172409 A1
(43) Pub. Date: Jun. 18, 2026

(54) METAVERSE INTEGRATED AUTHENTICATION METHOD AND SYSTEM

(71) Applicant: CATALYSTER CORPORATION, Seoul (KR)

(72) Inventors: Hakjin LIM, Seoul (KR); Kangtae JEON, Seoul (KR)

(21) Appl. No.: 19/129,313

(22) PCT Filed: Dec. 15, 2022
(86) PCT No.: PCT/KR2022/020479

§ 371 Date: May 13, 2025

(30) Foreign Application Priority Data
Nov. 16, 2022 (KR) 10-2022-0153939

(51) Int. Cl. H04L 9/40; H04L 67/02

(52) U.S. Cl. CPC H04L 63/08; H04L 63/0815; H04L 63/0853; H04L 67/02

(57) ABSTRACT

Provided is a metaverse integrated authentication method. The metaverse integrated authentication method includes: transmitting, by a user terminal, an IDP login request; when the IDP login request is received, extracting, by a first ID provider, subscription information associated with a user of the user terminal from a first ID database; providing, by the first ID provider, the user terminal with an access token based on the extracted subscription information; transmitting, by the user terminal, a first login request for a public metaverse based on the provided access token; extracting, by a first server associated with the public metaverse, account information associated with the first login request from an account database; and performing, by the first server, authentication of the user terminal for the public metaverse based on the extracted account information.

### TECHNICAL FIELD

The present disclosure relates to a metaverse integrated authentication method and system, and particularly, to a metaverse integrated authentication method and system for managing and authenticating access rights of a user in a multiverse including a plurality of combined metaverses.

### BACKGROUND ART

A metaverse is a compound word of meta, meaning fictional or abstract, and universe, meaning the real world. The virtual world of a metaverse may mirror the physical interaction of objects in the real world as it is.

Typically, to use these metaverse services, it is necessary to complete membership registration and perform user authentication. However, when a user uses a multiverse service in which multiple metaverses are combined, it is cumbersome to perform user authentication each time the user enters a different metaverse.

### DISCLOSURE

### Technical Problem

In order to solve the foregoing problems, the present disclosure provides a metaverse integrated authentication method, a computer program stored in a computer-readable medium, a computer-readable medium and system (device) in which the computer program is stored.

### Technical Solution

The present disclosure may be implemented in a variety of ways, including a method, a system (apparatus), a computer program stored on a computer-readable medium, or a computer-readable media on which the computer program is stored.

An exemplary embodiment of the present disclosure provides a metaverse integrated authentication method performed by at least one processor, the metaverse integrated authentication method including: transmitting, by a user terminal, an IDP login request; when the IDP login request is received, extracting, by a first ID provider, subscription information associated with a user of the user terminal from a first ID database; providing, by the first ID provider, the user terminal with an access token based on the extracted subscription information; transmitting, by the user terminal, a first login request for a public metaverse based on the provided access token; extracting, by a first server associated with the public metaverse, account information associated with the first login request from an account database; and performing, by the first server, authentication of the user terminal for the public metaverse based on the extracted account information.

According to the exemplary embodiment of the present disclosure, the first ID provider may be associated with a first private metaverse. The metaverse integrated authentication method may further include: transmitting, by the user terminal, a second login request for the first private metaverse; and performing, by a second server associated with the first private metaverse, authentication of the user terminal for the first private metaverse based on information pre-authenticated by the first ID provider.

According to the exemplary embodiment of the present disclosure, the transmitting of, by the user terminal, the second login request for the first private metaverse may include transmitting the second login request when a user of the user terminal enters an area associated with the first private metaverse in a virtual world.

According to the exemplary embodiment of the present disclosure, the metaverse integrated authentication method may further include: when the authentication of the user terminal for the first private metaverse is completed, obtaining, by the second server, user data associated with the user terminal from the first ID database; and providing the user terminal with services provided by the first private metaverse by using the obtained user data.

According to the exemplary embodiment of the present disclosure, the metaverse integrated authentication method may further include: when the IDP login request is received, extracting, by a second ID provider, subscription information associated with a user of the user terminal from a second ID database; and providing, by the second ID provider, the user terminal with an access token based on the extracted subscription information.

Another exemplary embodiment of the present disclosure provides a computer program stored in a computer-readable recording medium to execute the method in a computer.

Still another exemplary embodiment of the present disclosure provides a metaverse integrated authentication system including: a first ID provider for extracting subscription information associated with a user of a user terminal from a first ID database when an IDP login request is received from the user terminal, and providing the user terminal with an access token based on the extracted subscription information; and a first server for, when a first login request based on the access token is received from the user terminal, extracting account information associated with the first login request from an account database and performing authentication of the user terminal for a public metaverse based on the extracted account information.

According to the exemplary embodiment of the present disclosure, the metaverse integrated authentication system may further include a second server for, when a second login request for a first private metaverse is received from the user terminal, performing authentication of the user terminal for the first private metaverse based on information pre-authenticated by the first ID provider.

According to the exemplary embodiment of the present disclosure, the second server may obtain user data associated with the user terminal from the first ID database, and use the obtained user data to provide the user terminal with services provided by the first private metaverse.

According to the exemplary embodiment of the present disclosure, the metaverse integrated authentication system may further include a second ID provider for extracting subscription information associated with a user of the user terminal from a second ID database when an IDP login request is received from the user terminal, and providing the user terminal with an access token based on the extracted subscription information.

### Advantageous Effects

According to the various exemplary embodiments of the present disclosure, a user using the metaverse service may simply use the service by proving the authority through IDP login, without having to perform a separate membership registration or the like.

According to the various exemplary embodiments of the present disclosure, when a private metaverse associated with an ID provider exists, a user terminal may simply access the private metaverse to receive services without having to perform additional IDP logins or the like.

According to the various exemplary embodiments of the present disclosure, a user terminal may perform credentialing by a plurality of ID providers with a single IDP login, thereby simplifying access to the private metaverses associated with each ID provider and receiving the service.

According to the various exemplary embodiments of the present disclosure, a user may freely use the public metaverse and the private metaverse associated with the corresponding ID providers by performing a single IDP login, and receive services that are appropriate to his/her situation based on user data.

The effects of the invention are not limited to those mentioned above, and other effects not mentioned will be apparent from the description of the claims to a person of ordinary skill in the art to which the present disclosure belongs.

### DESCRIPTION OF DRAWINGS

Exemplary embodiments of the present disclosure will be described with reference to the accompanying drawings, which are described below, wherein like reference numerals indicate like elements, but are not limited thereto.

FIG. 1 is a diagram illustrating an example of a plurality of metaverses according to an exemplary embodiment of the present disclosure.

FIG. 2 is a diagram illustrating an internal configuration of a first physical server unit according to the exemplary embodiment of the present disclosure.

FIG. 3 is a diagram illustrating an example of performance of integrated authentication in a metaverse according to the exemplary embodiment of the present disclosure.

FIG. 4 is a diagram illustrating an example of performance of integrated authentication in a multiverse according to the exemplary embodiment of the present disclosure.

FIG. 5 is a diagram illustrating an example of performance of multi-integrated authentication in a multiverse according to the exemplary embodiment of the present disclosure.

FIG. 6 is a diagram illustrating an example of performance of integrated authentication in a multiverse according to the exemplary embodiment of the present disclosure.

FIG. 7 is a diagram illustrating an example of a metaverse integrated authentication method according to an exemplary embodiment of the present disclosure.

### BEST MODE

Hereinafter, particular contents for carrying out the present disclosure will be described in detail with reference to the accompanying drawings. However, in the following description, specific descriptions of widely known features or configurations will be omitted if they may unnecessarily obscure the essence of the present disclosure.

In the attached drawings, identical or corresponding components are given the same reference numeral. In addition, in the description of the exemplary embodiments below, overlapping description of the same or corresponding constituent elements may be omitted. However, the omission of any description of a component is not intended to prevent such component from being included in any exemplary embodiment.

The advantages and characteristics of the disclosed exemplary embodiment, and a method for achieving the advantages and characteristics will become clear by referring to the exemplary embodiment, which is described in detail, together with the accompanying drawings. However, the present disclosure is not limited to exemplary embodiments disclosed herein but will be implemented in various forms, and the exemplary embodiments are provided so that the present disclosure is completely disclosed, and a person of ordinary skilled in the art may fully understand the scope of the present disclosure.

Terms used in this specification will be briefly described, and the disclosed exemplary embodiments will be described in detail. The terms used in this specification have been selected as currently widely used general terms as possible while considering the functions in the present disclosure, but this may vary depending on the intention or precedent of the engineer in the related field, the emergence of new technology, and the like. In addition, in specific cases, there are also terms arbitrarily selected by the applicant, and in this case, the meaning will be described in detail in the description of the relevant invention. Accordingly, the term used in the present disclosure should be defined based on the meaning of the term and the entire contents of the present disclosure, simply not a name of the term.

In the present specification, the singular expression includes the plural expression unless the context clearly dictates the singular. Further, the plural expression includes the singular expression unless the context clearly dictates the plural. Throughout the specification, when a part “includes” other constituent elements, this means that other constituent elements may be further included, rather than excluding other constituent elements, unless otherwise stated.

In the present disclosure, terms such as “comprises”, “comprising”, and the like may indicate that features, steps, operations, elements and/or constituent elements are present, but this term does not exclude the addition of one or more other functions, steps, operations, elements, constituent elements, and/or combinations thereof.

In the present disclosure, when a particular constituent element is referred to as “is coupled to”, “is combined with”, “is connected to”, or “reacts” to another constituent element, the particular constituent element may be directly coupled to, combined with, and/or connected to or may react with another constituent element, but the present disclosure is not limited thereto. For example, there may be one or more intermediate constituent elements between a particular constituent element and another constituent element. In addition, in the present disclosure, “and/or” may include each of one or more of the listed items or combinations of at least a portion of one or more of the items.

In the present disclosure, terms such as “a first” and “a second” are used to distinguish a specific constituent element from other constituent elements, and the above-described constituent elements are not limited by these terms. For example, a “first” constituent element may be an element of the same or similar type as a “second” constituent element.

In the present disclosure, “user terminal” may refer to any computing device capable of wired establishing and/or wireless communication and used to receive virtual world services (e.g., metaverse services), and may include, but is not limited to, Virtual Reality (VR) devices, Augmented Reality (AR) devices, and the like.

In the present disclosure, “physical simulation” may refer to simulating physical phenomena, such as rigid body dynamics (including collision detection), soft body dynamics, and fluid dynamics for virtual objects in a virtual world.

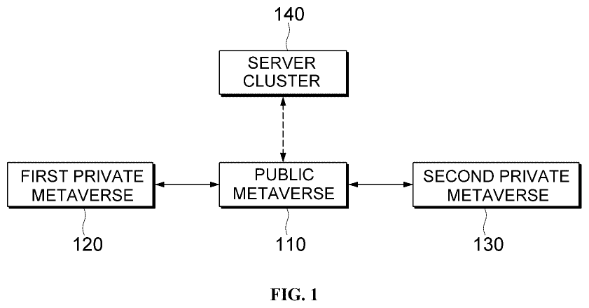

FIG. 1 is a diagram illustrating an example of a plurality of metaverses according to an exemplary embodiment of the present disclosure. As illustrated, the metaverse may include a public metaverse 110 and a private metaverse 120 or 130. Here, the public metaverse 110 may refer to an open virtual world that is open to all users, and the private metaverse 120 or 130 may refer to a closed virtual world that is open to users authorized by an owner.

According to the exemplary embodiment, the public metaverse 110 and the first private metaverse 120 and/or the second private metaverse 130 may be connected to form a multiverse. In this case, the public metaverse 110 may be the central point connecting all metaverses, and the plurality of private metaverses 120 and 130 may each refer to a virtual world that is independent and separate from the other metaverses. For example, in the virtual world of the public metaverse 110, a particular scoped area representing a particular building or the like may be configured as an arbitrary private metaverse, and the scoped area may be configured to be accessible only to authorized users.

According to the exemplary embodiment, the public metaverse 110 may be operated by a server cluster 140. Additionally, the private metaverse may be operated by different server clusters. Here, the server cluster 140 may refer to a set of physical server units that perform physical simulations to drive the virtual world and determine, process, and/or manage the movements of objects in the virtual world based on AI. In this case, each of the server clusters managing different metaverses may communicate with each other to transmit and receive data and/or information needed to drive the virtual world.

In FIG. 1, the public metaverse 110 is illustrated as being connected with two metaverses, the first private metaverse 120 and the second private metaverse 130, but without limitation, the public metaverse 110 may be connected with any number of metaverses.

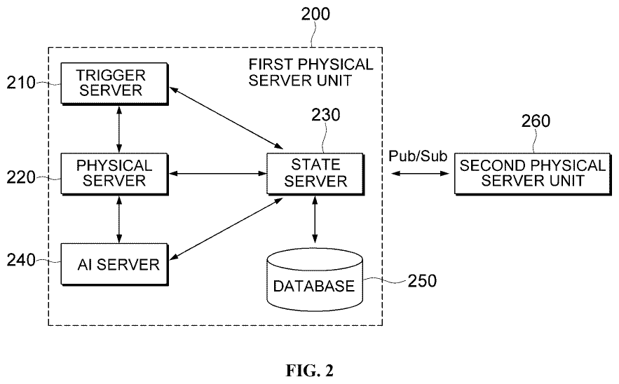

FIG. 2 is a diagram illustrating an internal configuration of the first physical server unit 200 according to the exemplary embodiment of the present disclosure. As described above, the metaverse may be managed by a server cluster, which may consist of at least one physical server unit. As illustrated, the first physical server unit 200 may include a trigger server 210, a physical server 220, a state server 230, an AI server 240, a database 250, and the like.

According to the exemplary embodiment, the trigger server 210 may be a server for managing collisions between objects present in the virtual world, or for handling events when an object enters a certain area. In other words, the trigger server 210 may be used to handle logic, such as implementing functionality of an object.

According to the exemplary embodiment, the physical server 220 may drive a physical engine to simulate the physical laws of the virtual world. For example, the physical server 220 may periodically perform physical simulations at regular time intervals on a frame-by-frame basis. Further, the state data of the objects generated as a result of these physical simulations may be transmitted to the trigger server 210, the state server 230, the AI server 240, and the like. That is, the trigger server 210, the state server 230, and/or the AI server 240 may mirror state data of the objects and fetch the mirrored state data.

According to the exemplary embodiment, the state data may be combined on a cell-by-cell basis to form a batch and then transmitted to the respective servers. Here, the state data may include information about at least some of the object's current position, direction, velocity, and angular velocity. In this case, each server which has obtained the state data may synchronize only the values that have changed in each frame, thereby reducing the network traffic required for data synchronization.

According to the exemplary embodiment, the state server 230 may handle the need to transmit state data to multiple targets. For example, the physical server 210 may not be suitable for transmitting large amounts of data because it uses most of its CPU resources for physical simulations, and accordingly, when data transmission to multiple targets is required, the state server 230 may transmit data that is being mirrored.

Additionally or alternatively, the state server 230 may additionally have information about objects that is determined not to be necessary to perform the simulation by the physical server 210, and may continuously store such information in the database 250. Additionally or alternatively, the state server 230 may communicate with the trigger server 210, the AI server 240, and the physical server 220 to manage the creation, destruction, movement, and/or change of objects, act as an API gateway to provide APIs to the outside, and act as a message router to transmit control messages from the outside to the other servers.

According to the exemplary embodiment, the AI server 240 may be responsible for the Artificial Intelligence (AI) of the objects and may be deployed separately from the physical server 220 as it requires a lot of CPU resources. For example, the AI server 240 may process or manage any object to perform directions or the like on its own.

According to the exemplary embodiment, the first physical server unit 200 may transmit and receive data to and from the second physical server unit 260 via data publish and subscribe. In this way, the efficiency of transmitting and receiving data may be improved when transmitting data to a plurality of targets by using the data publish and subscribe method.

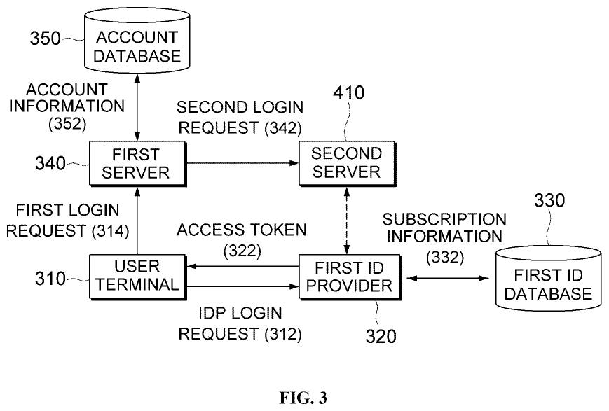

FIG. 3 is a diagram illustrating an example of performance of integrated authentication in a metaverse according to the exemplary embodiment of the present disclosure. According to the exemplary embodiment, a user of a metaverse may log in to a metaverse service via credentials. For example, a user may authenticate his or her credentials through a first identity (ID) provider 320 and use a metaverse service. Here, an ID provider may refer to a service provider and/or device that stores and/or manages digital identities.

For credentialing, the user terminal 310 may transmit an IDP login request 312 to the first ID provider 320. In this case, the first ID provider 320 may obtain subscription information 332 of a user associated with the user terminal 310 from a first ID database 330, and may verify an authority of the user terminal 310 based on the obtained subscription information 332. For example, the first ID provider 320 may check the user's access rights, permitted operations, and the like based on the subscription information 332. The first ID provider 320 may then provide an access token 322 to the user terminal 310.

According to the exemplary embodiment, the user terminal 310 may transmit a first login request 314 to the first server (e.g., server cluster) 340 associated with the public metaverse based on the provided access token 322. In this case, the first server 340 may verify the access token 322 included in the first login request 314 and perform user authentication. When the user authentication is completed as described above, the first server 340 may obtain account information 352 associated with the corresponding user terminal 310 from the account database 350 to authorize access for the user.

With this configuration, a user using the metaverse service may simply use the service by proving the authority through IDP login, without having to perform a separate membership registration or the like.

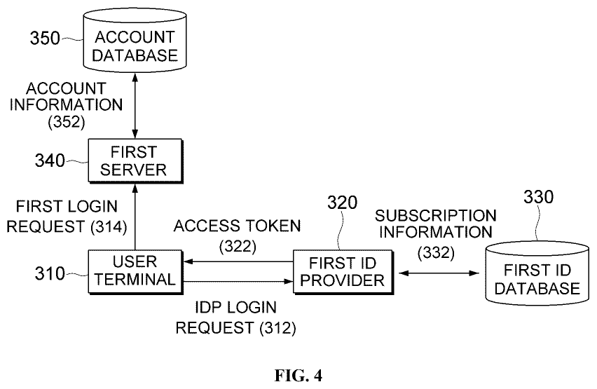

FIG. 4 is a diagram illustrating an example of performance of integrated authentication in a metaverse according to the exemplary embodiment of the present disclosure. As described above, the user terminal 310 may access the public metaverse associated with the first server 340 by performing credentials through the first ID provider 320.

According to the exemplary embodiment, the first ID provider 320 may be associated with any private metaverse (e.g., the first private metaverse). Here, when a user is a member of the first ID provider 320, the user may be designated as a first class citizen of the corresponding private metaverse. That is, when the user is a member of the first ID provider 320, the user may use various services provided by the private metaverse.

As described above in FIG. 3, the user terminal 310 may transmit a first login request 314 to the first server 340 associated with the public metaverse based on the provided access token 322. In this case, the first server 340 may verify the access token 322 included in the first login request 314 and perform user authentication.

Additionally, the user terminal 310 may access a private metaverse associated with the public metaverse. For example, the user terminal 310 and/or the first server 340 may transmit a second login request 342 to the second server 410 associated with the first private metaverse. When such a request is received, the second server 410 may permit the user access to the first private metaverse because the user has already been authenticated.

In this configuration, when a private metaverse associated with the first ID provider 320 exists, the user terminal 310 may simply access the private metaverse to receive services without having to perform additional IDP logins or the like.

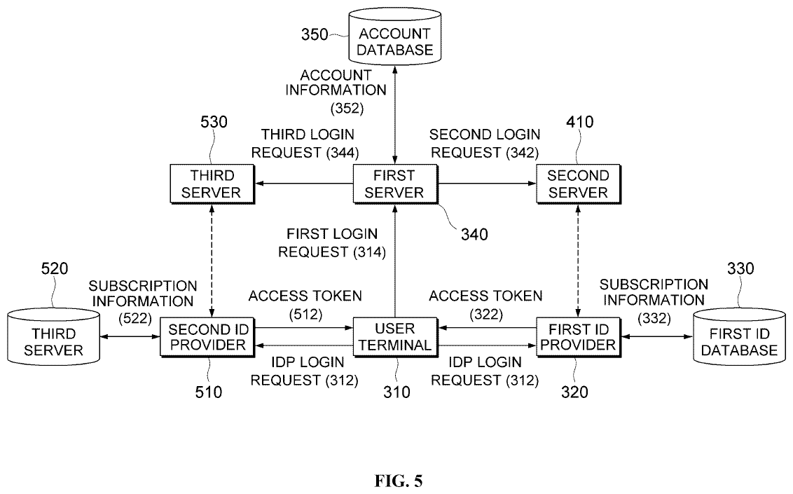

FIG. 5 is a diagram illustrating an example of performance of multi-integrated authentication in a metaverse according to the exemplary embodiment of the present disclosure. As illustrated, the user terminal 310 may perform authentication on multiple private metaverses with a single IDP login.

According to the exemplary embodiment, when the user terminal 310 transmits the IDP login request 312, the IDP login request 312 may be transmitted to a plurality of ID providers. For example, the IDP login request 312 may be transmitted to a first ID provider 320 and a second ID provider 510. In this case, the first ID provider 320 may obtain the subscription information 332 from the first ID database 330 to authenticate the user and provide with user terminal 310 with an access token 322 associated with the user. Similarly, the second ID provider 510 may obtain the subscription information 522 from the second ID database 520 to perform authentication for the user and provide the user terminal 310 with an access token 512 associated with the user.

According to the exemplary embodiment, the user terminal 310 may transmit the first login request 314 to the first server 340 by using the received plurality of access tokens 322 and 512. In this case, the first server 340 may verify the access tokens 322 and 512 included in the first login request 314 and perform user authentication.

According to the exemplary embodiment, the user terminal 310 may access a private metaverse associated with the public metaverse. For example, the user terminal 310 and/or the first server 340 may transmit a second login request 342 to the second server 410 associated with the first private metaverse. Further, the user terminal 310 and/or the first server 340 may transmit a third login request 344 to the third server 530 associated with the second private metaverse. When such a request is received, the second server 410 and/or the third server 530 may permit the user access to the first and second private metaverses because the authentication of the user has already been completed.

With such a configuration, the user terminal 310 may perform credentialing by the plurality of ID providers with a single IDP login, thereby simplifying access to the private metaverses associated with each ID provider and receiving the service.

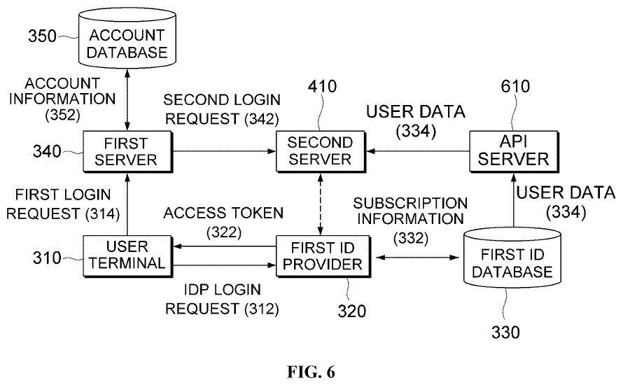

FIG. 6 is a diagram illustrating an example of performance of integrated authentication in a multiverse according to the exemplary embodiment of the present disclosure. As described above, the user terminal 310 may access the public metaverse associated with the first server 340 by performing credentialing through the first ID provider 320. That is, the user terminal 310 may transmit a first login request 314 to the first server 340 associated with the public metaverse based on the provided access token 322. In this case, the first server 340 may verify the access token 322 included in the first login request 314 and perform user authentication.

Additionally, the user terminal 310 may access a private metaverse associated with the public metaverse. For example, the user terminal 310 and/or the first server 340 may transmit a second login request 342 to the second server 410 associated with the private metaverse. When such a request is received, the second server 410 may permit the user access to the private metaverse because the authentication of the user has already been completed.

According to the exemplary embodiment, once the authentication of the user terminal 310 for the private metaverse has been authenticated, the second server 410 may obtain user data 334 associated with the user terminal 310 from the first ID database 330. For example, the API server 610 may obtain the user data 334 from the first ID database 330, and the second server 410 may receive the user data 334 from the API server 610. In this case, the second server 410 may use the obtained user data 334 to provide the user terminal 310 with services provided by the private metaverse. Here, the user data 334 is data associated with the user, such as the user's age, gender, height, health status, and the like, which may be input from the user or acquired by any external device.

With this configuration, a user may freely access the public metaverse and the private metaverse associated with the first ID provider 320 by performing a single IDP login, as well as receive services appropriate to his or her situation based on the user data 334.

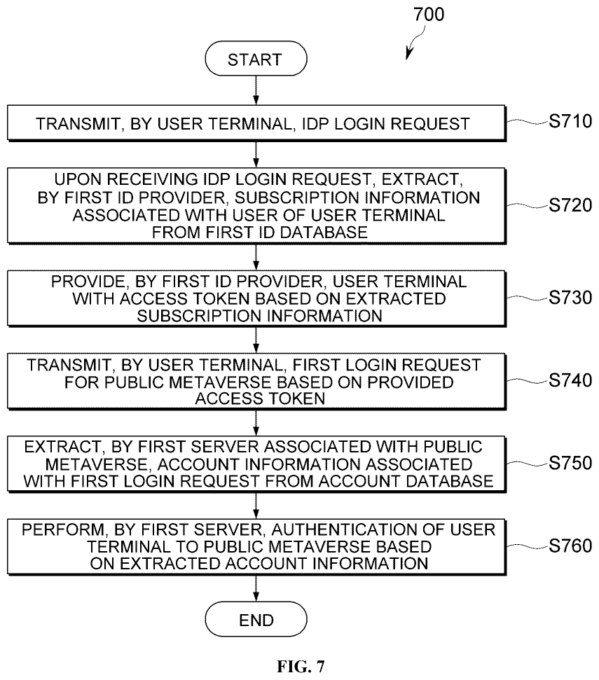

FIG. 7 is a diagram illustrating an example of a metaverse integrated authentication method 700 according to an exemplary embodiment of the present disclosure. The metaverse integrated authentication method 700 may be performed by at least one processor (e.g., at least one processor of a metaverse integrated authentication system). The metaverse integrated authentication method 700 may be initiated by a user terminal transmitting an IDP login request (S710).

When the IDP login request is received, the first ID provider may extract subscription information associated with the user of the user terminal from the first ID database (S720). Here, the first ID provider may be associated with a first private metaverse. In this case, the first ID provider may provide the user terminal with an access token based on the extracted subscription information (S730).

The user terminal may transmit a first login for the public metaverse based on the provided access token (S740). When the first login request is received, a first server associated with the public metaverse may extract account information associated with the first login request from an account database (S750). The first server may then perform authentication of the user terminal to the public metaverse based on the extracted account information (S760). When the authentication is completed, the user terminal may be permitted to access the public metaverse, and the user may thereby use the various services provided by the public metaverse.

According to the exemplary embodiment, the public metaverse may be associated with at least one private metaverse. To access the private metaverse, the user terminal may transmit a second login request for the first private metaverse. For example, when a user of the user terminal enters an area associated with the first private metaverse in the virtual world, the second login request may be transmitted. In this case, the second server associated with the first private metaverse may perform authentication to the first private metaverse of the user terminal based on the information pre-authenticated by the first ID provider.

According to the exemplary embodiment, when the authentication of the user terminal for the first private metaverse is completed, the second server may obtain user data associated with the user terminal from the first ID database. Further, the second server may use the obtained user data to provide the user terminal with services provided by the first private metaverse.

According to the exemplary embodiment, when the IDP login request is received, the second ID provider may extract subscription information associated with the user of the user terminal from the second ID database. Further, the second ID provider may provide the user terminal with an access token based on the extracted subscription information. Here, the second ID provider may be associated with a second private metaverse. In this case, the user terminal may transmit a first login request and perform authentication by using both the access token obtained from the first ID provider, the access token obtained from the second ID provider, and the like.

According to the exemplary embodiment, the user terminal may transmit a third login request for the second private metaverse. For example, when a user of the user terminal enters an area associated with the second private metaverse in a virtual world, the user terminal may transmit a third login request. In this case, the third server associated with the second private metaverse may perform authentication to the second private metaverse of the user terminal based on the information pre-authenticated by the second ID provider.

The foregoing method and/or various exemplary embodiments may be implemented by a digital electronic circuit, computer hardware, firmware, software, and/or a combination thereof. Various exemplary embodiments of the present disclosure may be executed by a data processing device, for example, one or more programmable processors and/or one or more programmable computing devices, or may be implemented as a computer-readable recording medium and/or a computer program stored in a computer-readable recording medium. The computer program may be written in any form of programming language, including a compiled language or an interpreted language, and may be distributed in any form, such as a stand-alone program, module, and subroutine. A computer program may be distributed through a single computing device, a plurality of computing devices connected through the same network, and/or a plurality of computing devices distributed to be connected through a plurality of different networks.

The methods and/or various exemplary embodiments described above may be performed by one or more processors configured to execute one or more computer programs that process, store, and/or manage any function, functions, and the like by being operated based on input data or generating output data. For example, the method and/or various exemplary embodiments of the present disclosure may be performed by a special-purpose logic circuit, such as a Field Programmable Gate Array (FPGA) or an Application Specific Integrated Circuit (ASIC), and a device and/or system for performing the method and/or various exemplary embodiments of the present disclosure may be implemented as a special-purpose logic circuit, such as an FPGA or an ASIC.

One or more processors executing a computer program may include a general purpose or special purpose microprocessor and/or one or more processors of any kind of digital computing device. The processor may receive an instruction and/or data from each of the read-only memory and the random access memory, or receive an instruction and/or data from the read-only memory and the random access memory. In the present disclosure, the constituent components of the computing device performing the method and/or exemplary embodiments may include one or more processors for executing instructions, one or more memory devices for storing instructions and/or data.

According to the exemplary embodiment, the computing device may transceive data with one or more large-capacity storage devices for storing data. For example, the computing device may receive data from a magnetic disc or an optical disc and/or transmit the data to the magnetic disc or the optical disc. A computer readable storage medium suitable for storing instructions and/or data associated with the computer program may include a predetermined type of non-volatile memory including a semiconductor memory device, such as an Erasable Programmable Read-Only Memory (EPROM), an Electrically Erasable PROM (EEPROM), and a flash memory device, but is not limited thereto. For example, the computer readable storage medium may include an internal hard disc or a portable disc, such as a magnetic disc, an optical magnetic disc, and CD-ROM and DVD-ROM discs.

In order to provide interaction with a user, the computing device may include a display device (for example, a Cathode Ray Tube (CRT) and a Liquid Crystal Display (LCD)) for providing or displaying information to the user and a pointing device (for example, a keyboard, a mouse, and a trackball) capable of providing an input and/or an instruction to the computing device, but is not limited thereto. That is, the computing device may further include a predetermined different type of devices for providing interaction with a user. For example, for the interaction with the user, the computing device may provide the user with a predetermined type of sensory feedback including a visual feedback, an audible feedback, and/or a tactile feedback. In this regard, the user may provide input to the computing device through various gestures, such as visual, voice, and motion.

In the present disclosure, various exemplary embodiments may be implemented in a computing system including a back-end component (for example, a data server), a middleware component (for example, an application server), and/or a front-end component. In this case, the constituent elements may be mutually connected by a predetermined type or medium of digital data communication, such as a communication network. For example, the communication network may include a Local Area Network (LAN) and a Wide Area Network (WAN).

The computing device based on the illustrative exemplary embodiments described in the present specification may be implemented by using hardware and/or software which includes a user device, a User Interface (UI) device, a user terminal, or a client device and is configured to interact with a user. For example, the computing device may include a portable computing device, such as a laptop computer. Additionally or alternatively, the computing device may include a Personal Digital Assistant (PDA), a tablet PC, a game console, a wearable device, an Internet of Things (IoT) device, a Virtual Reality (VR) device, an Augmented Reality (AR) device, and the like, but is not limited thereto. The computing device may further include a different type of device configured to interact with a user. Additionally, the computing device may include a portable communication device (for example, a mobile phone, a smart phone, and a wireless cellular phone) suitable for wireless communication through a network, such as a mobile communication network. The computing device may be configured to wirelessly communicate with a network server by using wireless communication technologies, such as Radio Frequency (RF), Microwave Frequency (MWF), and/or Infrared Ray Frequency (IRF) and/or protocols.

In the present disclosure, various exemplary embodiments including specific structural and function details are illustrative. Therefore, the exemplary embodiments of the present disclosure are not limited to the foregoing, and may be implemented in various different forms. In addition, the term used in the present disclosure is for describing some exemplary embodiments, and is not interpreted to limit the exemplary embodiment. For example, singular words and the foregoing may be construed to include plural forms unless the context clearly indicates otherwise.

All of the terminologies containing one or more technical or scientific terminologies have the same meanings that persons skilled in the art understand ordinarily unless they are not defined otherwise. In addition, commonly used terms, such as dictionary-defined terms, should be interpreted to have a meaning consistent with their meaning in the context of the relevant art.

In the present specification, the present disclosure has been described in relation to some exemplary embodiments, but the present disclosure may be variously modified and changed within the range without departing from the scope of the present disclosure that those skilled in the art may understand. Furthermore, such modifications and changes are to be considered as falling within the scope of the claims appended to the present specification.

1. A metaverse integrated authentication method performed by at least one processor, the metaverse integrated authentication method comprising:
transmitting, by a user terminal, an IDP login request;
when the IDP login request is received, extracting, by a first ID provider, subscription information associated with a user of the user terminal from a first ID database;
providing, by the first ID provider, the user terminal with an access token based on the extracted subscription information;
transmitting, by the user terminal, a first login request for a public metaverse based on the provided access token;
extracting, by a first server associated with the public metaverse, account information associated with the first login request from an account database; and
performing, by the first server, authentication of the user terminal for the public metaverse based on the extracted account information.

2. The metaverse integrated authentication method of claim 1, wherein the first ID provider is associated with a first private metaverse, and the metaverse integrated authentication method further comprises:
transmitting, by the user terminal, a second login request for the first private metaverse; and
performing, by a second server associated with the first private metaverse, authentication of the user terminal for the first private metaverse based on information pre-authenticated by the first ID provider.

3. The metaverse integrated authentication method of claim 2, wherein the transmitting of, by the user terminal, the second login request for the first private metaverse includes transmitting the second login request when a user of the user terminal enters an area associated with the first private metaverse in a virtual world.

4. The metaverse integrated authentication method of claim 2, further comprising:
when the authentication of the user terminal for the first private metaverse is completed, obtaining, by the second server, user data associated with the user terminal from the first ID database; and
providing services provided by the first private metaverse to the user terminal by using the obtained user data.

5. The metaverse integrated authentication method of claim 1, further comprising:
when the IDP login request is received, extracting, by a second ID provider, subscription information associated with a user of the user terminal from a second ID database; and
providing, by the second ID provider, the user terminal with an access token based on the extracted subscription information.

6. A computer program stored in a computer-readable recording medium to execute the method of claim 1 to in a computer.

7. A metaverse integrated authentication system comprising:
a first ID provider for extracting subscription information associated with a user of a user terminal from a first ID database when an IDP login request is received from the user terminal, and providing the user terminal with an access token based on the extracted subscription information; and
a first server for, when a first login request based on the access token is received from the user terminal, extracting account information associated with the first login request from an account database and performing authentication of the user terminal for a public metaverse based on the extracted account information.

8. The metaverse integrated authentication system of claim 7, further comprising:
a second server for, when a second login request for a first private metaverse is received from the user terminal, performing authentication of the user terminal for the first private metaverse based on information pre-authenticated by the first ID provider.

9. The metaverse integrated authentication system of claim 8, wherein the second server obtains user data associated with the user terminal from the first ID database, and uses the obtained user data to provide the user terminal with services provided by the first private metaverse.

10. The metaverse integrated authentication system of claim 7, further comprising:
a second ID provider for extracting subscription information associated with a user of the user terminal from a second ID database when an IDP login request is received from the user terminal and providing the user terminal with an access token based on the extracted subscription information.
